(19) United States
(12) Patent Application Publication
(10) Pub. No.: US 2014/0197736 A1
(43) Pub. Date: Jul. 17, 2014

(54) FILAMENT DETECTION CIRCUIT

(71) Applicants: Eliseo Carcamo, Apodaca (MX); Markus Ziegler, Watertown, MA (US)

(72) Inventors: Eliseo Carcamo, Apodaca (MX); Markus Ziegler, Watertown, MA (US)

(73) Assignee: OSRAM SYLVANIA Inc., Danvers, MA (US)

(21) Appl. No.: 13/741,560

(22) Filed: Jan. 15, 2013

(51) Int. Cl. H01J 1/15

(52) U.S. Cl. CPC H01J 1/15
USPC 315/114

(57) ABSTRACT

A ballast including a driver circuit, a filament heating circuit, a current detector circuit, and a control circuit is provided. The driver circuit generates an oscillating current signal. The filament heating circuit heats filaments of a lamp connected to the ballast and includes a heating transformer with primary and secondary windings and a switching circuit. The primary winding is connected to the driver circuit and the switching circuit. The secondary winding is connected to the primary winding and may be connected to the lamp. The duty cycle of the switching circuit controls current provided from the driver circuit to the primary winding to heat the lamp. The current detector circuit is connected to the switching circuit and detects a parameter of the current in the primary winding, which indicates the number of lamp filaments connected to the ballast. The control circuit controls the driver circuit based on the detected parameter.

### TECHNICAL FIELD

The present invention relates to lighting, and more specifically, to electronic ballasts for lighting.

### BACKGROUND

Electronic ballasts are connected between a power source and a lamp set of one or more lamps to provide a required power to ignite the lamp set and to provide a regulated power to energize the lamp set. In a pre-heat ballast, the ballast operates in at least three modes: (1) a preheat mode; (2) an ignition mode; (3) a normal operating mode. In the preheat mode, the ballast provides power to the lamp filaments of the lamp set to heat the lamp filaments to a pre-defined temperature needed to ignite the lamp set. In particular, the ballast provides a moderate voltage level (e.g., 7 volts peak) to the lamp set for a limit period of time (e.g., one second or less). At this point, the ballast may switch to the ignition mode where a relatively high voltage (e.g., 500 volts peak) is applied to the lamp set in order to ignite the lamp set. Once the lamp set has been ignited, the ballast operates in the normal operating mode and provides a relatively steady voltage to the lamp set to keep the lamp set energized.

### SUMMARY

A conventional ballast, such as described above, results in a high current occurring during the ignition mode. If the lamp set is not properly connected to the ballast, the current generated during the ignition mode is potentially dangerous due to the risk of shock. As such, a ballast that reduces or eliminates the high current that is provided during the ignition mode if the lamp set is not properly connected to the ballast would be useful.

Embodiments of the present invention provide a filament detection circuit that allows a ballast to ignite a lamp set only if the lamp set is properly connected to the ballast. Embodiments include a driver circuit for generating an oscillating current signal, and a filament heating circuit for heating filaments of the at least one lamp. The filament heating circuit comprises a heating transformer and a switching circuit. The heating transformer includes a primary winding a secondary winding, each adapted for conducting current. The primary winding is connected to the driver circuit, and the secondary winding is coupled to the primary winding and adapted for connecting to the at least one lamp. The switching circuit is connected to the primary winding, and has a duty cycle for controlling the current signal provided from the driver circuit to the primary winding to heat the at least one lamp. A current detector circuit is connected to the switching circuit for detecting a particular parameter of the current conducted by the primary winding. The particular parameter, such as peak current, is indicative of a total number of particular lamp filaments connected to the ballast. A control circuit is connected to the current detector circuit and to the driver circuit. The control circuit is configured to generate and transmit an output signal to the driver circuit based on the particular parameter detected by the current detector circuit. The ballast may be configured to enable or disable ignition of the at least one lamp based on the particular parameter detected by the current detector circuit. Additionally or alternatively, the ballast may be configured to adjust the current signal provided to the at least one lamp for energizing lamp based on the particular parameter detected by the current detector circuit.

In an embodiment, there is provided a ballast. The ballast includes: a driver circuit to generate an oscillating current signal; a filament heating circuit to heat filaments of at least one lamp connected to the ballast, wherein the filament heating circuit includes: a heating transformer having a primary winding and a secondary winding, each adapted to conduct current, wherein the primary winding is connected to the driver circuit and the secondary winding is coupled to the primary winding and adapted to be connected to the at least one lamp; and a switching circuit connected to the primary winding, wherein the switching circuit has a duty cycle to control the current signal provided from the driver circuit to the primary winding to heat the at least one lamp; a current detector circuit connected to the switching circuit to detect a particular parameter of the current conducted by the primary winding, wherein the particular parameter is indicative of a total number of particular lamp filaments connected to the ballast; and a control circuit connected to the current detector circuit and to the driver circuit, wherein the control circuit is configured to generate and transmit an output signal to the driver circuit based on the particular parameter detected by the current detector circuit.

In a related embodiment, the particular parameter may be peak current. In another related embodiment, the secondary winding of the filament heating transformer may be adapted to connect to parallel-connected lamp filaments. In yet another related embodiment, the control circuit may be configured to generate and transmit a control signal to the driver circuit to prevent ignition of the at least one lamp based on the particular parameter detected by the current detector circuit. In still another related embodiment, the control circuit may be configured to generate and transmit an output signal to the driver circuit indicative of the total number of lamp filaments connected to the secondary winding based on the particular parameter detected by the current detector circuit. In yet still another related embodiment, the current detector circuit may be configured to generate a voltage signal representing the particular parameter, and the control circuit may be configured to receive the voltage signal and compare it to a reference voltage value in order to determine a total number of lamp filaments connected to the secondary winding.

In another embodiment, there is provided a ballast. The ballast includes: a filament heating transformer having a primary winding to conduct a first current and a secondary winding coupled to the primary winding to conduct a second current, wherein the secondary winding is adapted to be connected to a set of one or more lamp filaments in at least one lamp and to provide the second current to the set of one or more lamp filaments to heat the set of one or more lamp filaments, wherein the first current is a function of the second current; and a filament detection circuit connected to the primary winding of the filament heating transformer to detect a particular parameter of the first current and to determine a total number of lamp filaments connected to the secondary winding of the filament heating transformer based on the detected particular parameter of the first current.

In a related embodiment, the ballast may further include a driver circuit connected to the primary winding of the filament heating transformer to provide an oscillating current, wherein the first current may be generated from the oscillating current. In another related embodiment, the particular parameter may be peak current.

In still another related embodiment, the filament detection circuit may include a current detector circuit to detect the particular parameter of the first current and to generate a voltage value representing the detected particular parameter, and the filament detection circuit may include a control circuit to receive the generated voltage value and to determine a total number of lamp filaments connected to the secondary winding of the filament heating transformer as a function thereof. In a further related embodiment, the control circuit may be configured to compare the received generated voltage value to a reference voltage value in order to determine a total number of lamp filaments connected to the secondary winding of the filament heating transformer. In another further related embodiment, the ballast may be configured to be connected to a lamp set including two lamps connected together in series. In yet another further related embodiment, the ballast may be configured to prevent ignition of the lamp set when the received generated voltage value is less than reference voltage value and greater than a minimum voltage value.

In yet another related embodiment, the secondary winding of the filament heating transformer may be adapted to be connected to parallel-connected lamp filaments. In still yet another related embodiment, the ballast may be configured to be connected to a lamp set comprising a plurality of lamps connected together in series. In yet still another related embodiment, the ballast may be configured to be connected to a lamp set comprising a plurality of lamps connected together in parallel.

In another embodiment, there is provided a lamp system. The lamp system includes: a lamp set comprising at least one lamp, wherein the at least one lamp has a first lamp filament and a second lamp filament; and a ballast to energize the lamp set, wherein the ballast is connected to the first lamp filament of the at least one lamp, the ballast comprising: a driver circuit to provide an oscillating current signal; a filament heating transformer having a primary winding and a secondary winding coupled to the primary winding, wherein the primary winding is connected to the driver circuit to conduct a first current generated from the oscillating current signal provided by the driver circuit, wherein the secondary winding is adapted to be connected to the second lamp filament to conduct a second current to the second lamp filament to heat the second lamp filament, wherein the first current is a function of the first current; and a filament detector circuit to sense a parameter of the first current indicative of the total number of lamp filaments connected to the secondary winding of the heating transformer and preventing ignition of the lamp set based on the indicated total number of lamp filaments.

In a related embodiment, the second lamp filament may be tied to a resistor connected to earth ground to perform a risk of shock test. In a further related embodiment, the lamp set may further include a second lamp having a third lamp filament and a fourth lamp filament connected to the ballast. In a further related embodiment, the secondary winding may be adapted to be connected to the second filament of the first lamp and the third filament of the second lamp connected together in parallel.

### BRIEF DESCRIPTION OF THE DRAWINGS

The foregoing and other objects, features and advantages disclosed herein will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles disclosed herein.

FIG. 1 shows a schematic diagram, partially in block form, of a lamp system according to embodiments disclosed herein.

FIG. 2 is a schematic diagram, partially in block form, of a portion of the lamp system illustrated in FIG. 1 having a filament detection circuit according to embodiments disclosed herein.

FIG. 3 is a schematic diagram of a current detector circuit according to embodiments disclosed herein.

FIGS. 4A and FIG. 4B each illustrate a lamp configuration for use with a ballast according to embodiments disclosed herein.

### DETAILED DESCRIPTION

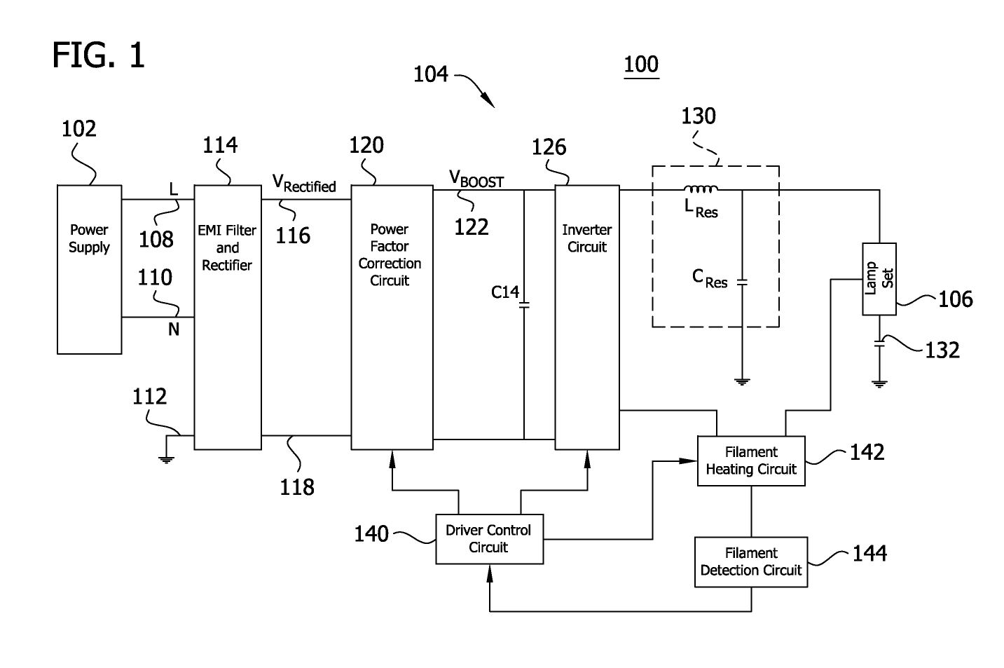

FIG. 1 shows a lamp system 100 that includes an input power source 102, such as but not limited to an alternating current (AC) power supply, an electronic ballast 104 (also referred to hereinafter as a ballast 104), and a lamp set 106. The electronic ballast 104 may be any type of electronic ballast known in the art, such as but not limited to a programmed start ballast. In some embodiments, the lamp set 106 includes one or more fluorescent lamps, and each fluorescent lamp includes a first filament and a second filament. However, the scope of the application contemplates the use of other types of lamps as well. Additionally, as described below, the lamp set 106 may include one lamp or a plurality of lamps connected together in series or in parallel.

The ballast 104 includes at least one high voltage input terminal (i.e., line voltage input terminal) 108 adapted for connecting to the alternating current (AC) power supply (e.g., standard 120V AC household power), a neutral input terminal 110, and a ground terminal 112 connectable to ground potential. An input AC power signal is received by the ballast 104 from the AC power supply 102 via the high voltage input terminal 108. The ballast 104 includes an electromagnetic interference (EMI) filter and a rectifier (e.g., full-wave rectifier) 114, which are illustrated together in FIG. 1. The EMI filter portion of the EMI filter and rectifier 114 prevents noise that may be generated by the ballast 104 from being transmitted back to the AC power supply. The rectifier portion of the EMI filter and rectifier 114 converts AC voltage received from the AC power supply to a rectified voltage. The rectifier portion includes a first output terminal connected to a DC bus 116 and a second output terminal connected to a ground potential at ground connection point 118. Thus, the EMI filter and rectifier 114 outputs a rectified voltage (V_{Rectified}) on the DC bus 116.

A driver circuit is connected to the EMI filter and rectifier 114, and receives the rectified voltage (V_{Rectified}) from the DC bus 116. From the received rectified voltage, the driver circuit generates an oscillating current signal for providing to the lamp set 106 in order to energize the one or more lamps of the lamp set 106. In the illustrated embodiment, the driver circuit comprises a power factor correction circuit 120, a shunt capacitor C14, an inverter circuit 126, a resonant circuit 130, and a driver control circuit 140. However, it is noted that the driver circuit may, and in some embodiments does, include only a portion of these components or additional and/or alternate components without departing from the scope of the invention.

In accordance with lamp system 100, the power factor correction circuit 120, which may be, and in some embodiments is, a boost converter, is connected to the first and second output terminals of the EMI filter and rectifier 114. The power factor correction circuit 120 receives the rectified voltage (V_{Rectified}) and produces a high voltage (V_{BOOST}) on a high DC voltage bus (“high DC bus”) 122. The shunt capacitor C14 is connected across the output of the power factor correction circuit 120. The inverter circuit 126 has an input connected to the power factor correction circuit 120 for receiving the high voltage (V_{BOOST}) from the power factor correction circuit 120. The inverter circuit 126 is configured to convert the high voltage (V_{BOOST}) from the power factor correction circuit 120 to an oscillating power signal for supplying to the lamp set 106. In some embodiments, the inverter circuit 126 includes a half bridge inverter having a first switching component and a second switching component. The switching components complementarily operate between a non-conductive state and a conductive state in order to produce the oscillating power signal. The resonant tank circuit 130 is connected to the inverter circuit 126. The resonant tank circuit 130 generates a power signal having a particular frequency for providing to the lamp set 106. In FIG. 1, a capacitor CRes and an inductor LRes are connected together and form the resonant tank circuit 130. A direct current (DC) blocking capacitor 132 is also connected in series with the lamp(s) of the lamp set 106 for blocking DC current from flowing into the lamp(s) of the lamp set 106.

In some embodiments, the driver control circuit 140 is configured to enable operation and/or control the operations of one or more of the components of the driver circuit. For example, the driver control circuit 140 may be, and in some embodiments is, configured to enable and control the operations of the power factor correction circuit 120 and the inverter circuit 126. In FIG. 1, the driver control circuit 140 includes one or more output terminals that connect the driver control circuit 140 to the power factor correction circuit 120, and the driver control circuit 140 generates one or more output signals that are provided to the power factor correction circuit 120 via the output terminals in order to control the power factor correction circuit 120. Similarly, the driver control circuit 140 includes and one or more output terminals that connect the driver control circuit 140 to the inverter circuit 126, and the driver control circuit 140 generates on or more output signals that are provided to the inverter circuit 126 in order to control the inverter circuit 126. For example, as described below, the driver control circuit 140 may be configured to generate a shutdown/disable output signal that is provided to the inverter circuit 126 in order to prevent the inverter circuit 126 from igniting the lamp set 106 during unsuitable conditions. Additionally or alternatively, the driver control circuit 140 may be, and in some embodiments is, configured to adjust/modify the operation of the inverter circuit 126 based on a number of detected lamp filaments connected to the ballast 104.

The lamp system 100 also includes a filament heating circuit 142 adapted to provide a filament power to heat (e.g., pre-heat) the filaments of the lamp(s) of the lamp set 106 in order to foster lamp ignition. In some embodiments, the filament heating circuit 142 includes a heating transformer connected between to the driver circuit and to the lamp set 106. In particular, the heating transformer has a primary winding connected to the driver circuit, and a secondary winding for connecting to the lamp set 106. During pre-heat mode, the heating transformer is induced with a voltage having a selected frequency in order to heat the lamp filaments. When the heating transformer is induced with the voltage, current flows through the primary and secondary windings.

The lamp system 100 includes a filament detection circuit 144 connected to the filament heating circuit and to the driver circuit (e.g., to the driver control circuit 140). The filament detection circuit 144 detects a particular parameter of the current through the primary winding of the heating transformer. The particular parameter is indicative of a total number of particular lamp filaments that are connected to the ballast 104. The filament detection circuit 144 generates an output signal (e.g., data signal, control signal) based on the detected particular parameter, and transmits the generated output signal to the driver circuit. In some embodiments, the filament detection circuit 144 generates a data signal indicating the number of particular lamp filaments connected to the ballast 104. The filament detection circuit transmits the data signal to the driver control circuit 140. The driver control circuit 140 is configured to analyze the number of particular lamp filaments connected to the ballast 104 and disable or adjust/modify the operation of the driver components accordingly. In other embodiments, the filament detection circuit 144 analyzes the number of particular lamp filaments connected to the ballast 104, and generates a control signal for controlling the operation of driver circuit and/or driver control circuit 140. The filament detection circuit 144 transmits the control signal to the driver circuit and/or driver control circuit 140. Upon receiving the control signal, the driver circuit and/or driver control circuit 140 is operated (e.g., disabled, modified/adjusted) in accordance with the control signal.

In this way, embodiments of the present invention are able to adjust the operation of the driver circuit based on the particular number of lamp filaments that are connected to the ballast. For example, if the number of particular lamp filaments connected the ballast 104 is less than an expected (i.e., reference) number of particular lamp filaments for the ballast 104, the ballast 104 may be prevented from entering ignition mode. This provides a safer ballast by eliminating the risk of shock associated with generating a high voltage level needed to ignite the lamp set, when the lamp set is incomplete or improperly connected to the ballast 104. Alternatively, if the number of particular lamp filaments connected the ballast 104 is less than an expected (i.e., reference) number of particular lamp filaments for the ballast 104, the ballast 104 may lower the ignition voltage level based on the number of particular lamp filaments actually connected to the ballast 104.

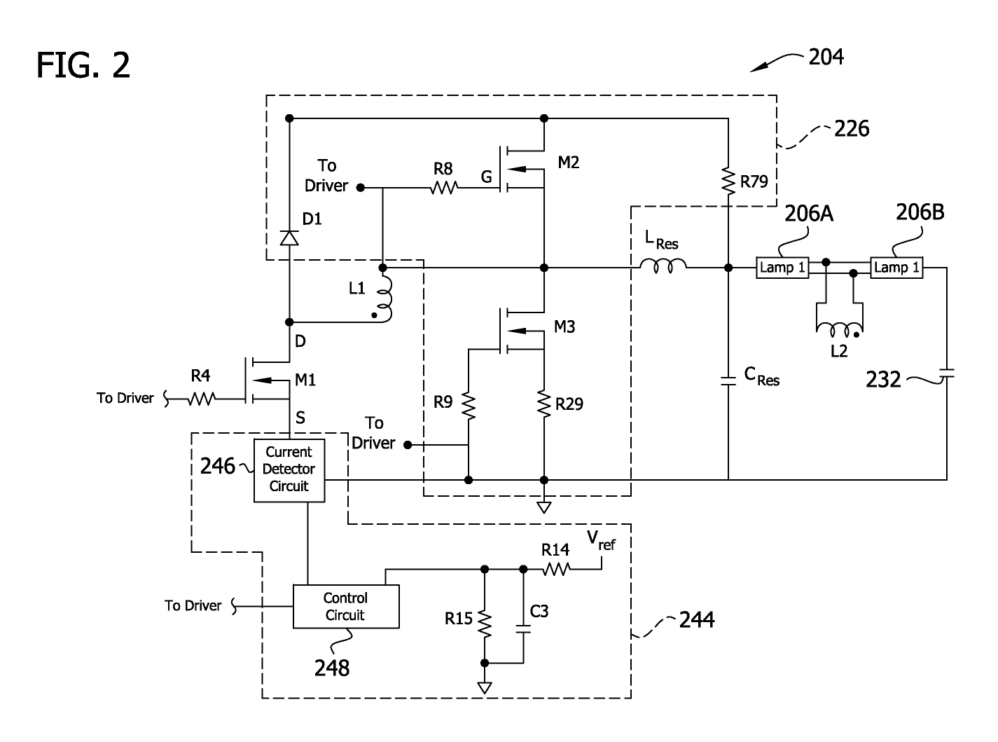

FIG. 2 is a partial schematic showing circuitry of a portion of a ballast 204 in accordance with the above-described components. The inverter circuit 226 is a half bridge inverter circuit comprising complementary metal-oxide-semiconductor field-effect transistors (MOSFETS) M2 and M3, a diode D1, and resistors R8, R9, R29, and R79. The filament heating circuit 142 comprises at least one heating transformer and a switching circuit connected to the heating transformer for controlling current through the heating transformer. The heating transformer comprises a primary winding L1 and a secondary winding L2, and may, and in some embodiments does, also include additional secondary windings that are not illustrated in FIG. 2. The switching circuit comprises a MOSFET M1 and a resistor R4. A gate terminal of the MOSFET M1 is connected to the driver circuit (e.g., driver control circuit 140) for receiving a control signal (“M1 control signal”) therefrom that controls operation of the MOSFET M1 between a conductive state and a non-conductive state. Thus, the driver control circuit 140 causes the switching circuit to have a particular duty cycle. The primary winding L1 of the heating transformer is connected to the switching circuit and to the inverter circuit 226 (broadly, driver circuit), such that the flow of current though the primary winding L1 is a function of the duty cycle of the switching circuit. In FIG. 2, the primary winding L1 is connected to a source terminal of the MOSFET M2 via the resistor R8, and to a drain terminal of the MOSFET M1. When the MOSFET M1 and the MOSFET M2 are both operating in conductive states, current is conducted via the MOSFET M1 though the primary winding L1 of the heating transformer to the filament detection circuit 244 for detecting the connection to lamp filaments.

The primary winding L1 is coupled (e.g., magnetically coupled) with the secondary winding L2 of the heating transformer such that the current through the primary winding L1 is a function of the current through the secondary winding L2, and the current through the secondary winding L2 is a function of the current though the primary winding L1. The secondary winding L2 is connected to lamp filaments of the lamp set for heating the lamp filaments. When the ballast 204 operates in a pre-heat mode, current flows through the primary winding L1, which induces a current flow through the secondary winding L2. However, if one of the lamp filaments is disconnected from the secondary winding L2, the current through the secondary winding L2 is reduced, which causes the current through the primary winding L1 to also be reduced, for a particular oscillating signal duty cycle previously selected/fixed for the filament heating circuit.

The filament heating circuit (e.g., the primary winding L1, the secondary winding L2, the MOSFET M1, and the resistor R4) is connected to the filament detection circuit 244. More particularly, in FIG. 2, the filament detection circuit 244 is connected to a source terminal of the MOSFET M1 for receiving the current conducted through the primary winding L1. The filament detection circuit 244 includes a current detector circuit 246 for detecting a parameter of the current (e.g., peak current) through the primary winding L1 of the heating transformer, and a control circuit (e.g., controller) 248 for analyzing the detected parameter to evaluate the number of lamp filaments connected to the secondary winding L2 of the heating transformer. In the illustrated filament detection circuit 244, the current detector circuit 246 generates a voltage value indicative of the detected current parameter and provides the voltage value to the control circuit 248. The control circuit 248 compares the voltage value provided by the current detector circuit 246 with a reference voltage value (e.g., threshold voltage value). In some embodiments, the reference voltage value represents a threshold voltage that must be detected when a pre-defined number of lamp filaments are properly connected to the secondary winding L2. The reference voltage value may be adjusted based on the number of lamp filaments and the type of lamps to which the ballast 204 is configured to be connected. As described below, the comparison of the provided voltage value with the reference voltage value is indicative of the number of lamp filaments connected to the secondary winding L2 of the heating transformer. The control circuit 248 may have a pre-defined (e.g., programmed) reference voltage value, or the control circuit 248 may receive a voltage generated by the ballast that is conditioned for use as the reference voltage value. For example, in FIG. 2, the control circuit 248 receives an input voltage (V_{ref}) from the driver circuit, and the filament detection circuit 244 includes conditioning components (voltage divider formed by resistors R14 and R15, and a filtering/stabilizing capacitor C3) to condition the input voltage for use as the reference voltage value.

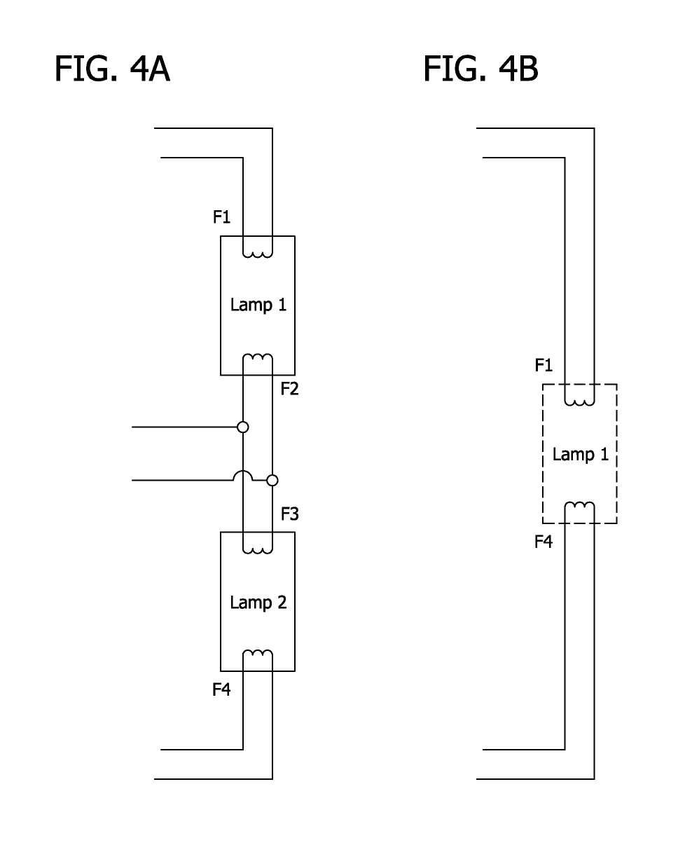

In FIG. 2, the ballast 204 is configured for detecting parallel filaments. In particular, the ballast 204 is adapted for connecting to a lamp set 206 having a two lamp configuration, as illustrated in FIG. 4A, or a one lamp configuration, as illustrated in FIG. 4B. As shown in the ballast 204 of FIG. 2 and in FIG. 4A, when the two lamp configuration is employed, a first lamp 206A and a second lamp 206B are connected together in series. The first lamp 206A has filaments F1 and F2, and the second lamp 206B has filaments F3 and F4. When the first lamp 206A and the second lamp 206B are properly connected to the ballast 204, the filament F2 of the first lamp 206A and the filament F3 of the second lamp F3 are connected together in parallel. The secondary winding L2 of the heating transformer is connected to the parallel-connected lamp filaments (F2 and F3) for heating those particular lamp filaments (F2 and F3). It should be noted that the filament heating circuit 244 may include additional transformer(s) (not shown) for heating the other lamp filaments (F1 and F4). Since the secondary winding L2 of the heating transformer is adapted for connecting to the parallel-connected lamp filaments (F2 and F3) and providing current thereto, the current through the secondary winding L2 is a function of the state of the connection of each these particular lamp filaments to the secondary winding L2. And, because the current through the secondary winding L2 is reflected in the current through the primary winding L1, the current through the primary winding L1 is a function of the state of connection of the secondary winding L2 to the lamp filaments. Accordingly, if both of the parallel-connected lamp filaments (F2 and F3) are electrically connected to the secondary winding L2, the current though the primary winding L1 has a first set of current parameter (e.g., amplitude, frequency, peak current) values. If only one of the parallel-connected lamp filaments (F2, F3) is electrically connected to the secondary winding L2, the current through the primary winding L1 has a second set of current parameter values. And, if both of the parallel-connected lamp filaments (F2 and F3) are not electrically connected (e.g., disconnected, unconnected) to the secondary winding L2, the current though the primary winding L1 has a third set of current parameter values.

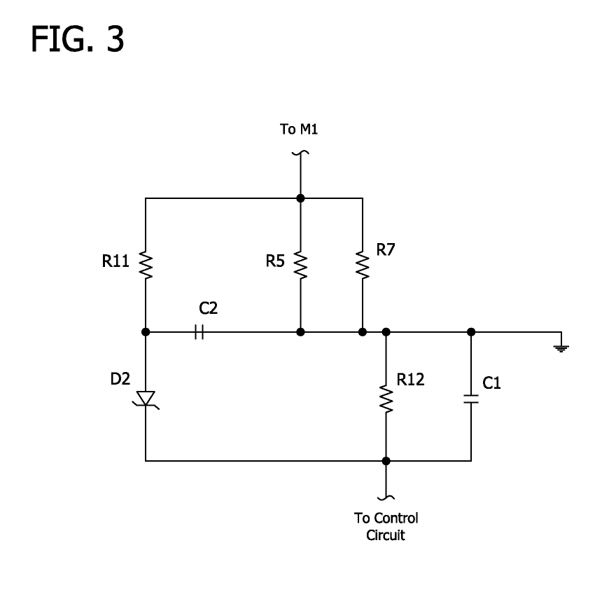

Referring to FIG. 3, in some embodiments the current detector circuit 346 is configured to detect the peak value of the current though the primary winding L1. FIG. 3 is a schematic illustrating such an exemplary current detector circuit 346. The exemplary current detector circuit 346 includes a resistive element, such as current sense resistors R5 and R7, connected to the source terminal of the MOSFET M1 for receiving current from the primary winding L1 and generating a voltage as a function of the received current. A rectifying element, such as but not limited to a diode D2, is connected to the resistive element and to the control circuit 248 for rectifying the voltage generated by the resistive element. In FIG. 3, a current limiting element, such as but not limited to a resistor R11, is connected between the source terminal of the MOSFET M1 and the rectifying element, and a capacitor C2 is connected between the resistive element and the rectifying element to reduce/eliminate noise. Additionally, a filter element, such as but not limited to parallel-connected resistor R12 and capacitor C1, is connected to the rectifying element and to the control circuit 248 for filtering the rectified voltage which is provided to the control circuit 248. The rectified voltage is representative of the peak current through the primary winding L1. As explained above, the control circuit 248 is configured to receive and compare the sensed voltage (e.g., voltage representative of the peak current) to the reference voltage in order to evaluate the connection of the secondary winding L2 to the lamp filaments.

Referring to FIGS. 2, 3, and 4, in one example, if the sensed voltage value is greater than the reference voltage value, the control circuit 248 generates an output signal to the driver circuit indicating that the parallel-connected filaments (F2 and F3) are both properly connected to the secondary winding L2. As such, the driver circuit may enable ignition of the lamp set 206. If the sensed voltage value is less than the reference voltage value but greater than about zero or some other minimum voltage value (e.g., pre-programmed minimum value), the control circuit 248 generates an output signal to the driver circuit indicating that only one of the parallel-connected filaments (F2 and F3) are properly connected to the secondary winding L2. As such, the driver circuit disables ignition of the lamp set 206. If the sensed voltage value is substantially zero (or less than some other minimum voltage value), the control circuit 248 generates an output signal to the driver circuit indicating that neither of the parallel-connected filaments (F2 and F3) are properly connected to the secondary winding L2. In some embodiments, the ballast 204 is adapted for operating in both a one-lamp configuration and a two-lamp configuration, and the driver circuit may enable ignition of the lamp set 206 in the one-lamp configuration (e.g., adjust power level for one lamp energizing only one lamp). Additionally or alternatively, the driver circuit may enable ignition of the ignition of the lamp set 206 based on whether the lamp filament terminal connection to the secondary winding L2 is shorted or open. If the sensed voltage value is less than a minimum voltage value but greater than a nominal voltage value (e.g., substantially zero), then control circuit 248 generates an output signal indicating that the parallel-detected lamp filaments are shorted. If the sensed voltage value is less than or substantially equal to the nominal voltage value, then the control circuit 248 generates an output signal indicating that the parallel-detected lamp filaments are open.

Accordingly, the driver circuit (e.g., driver control circuit 140) is configured to permit ignition and/or adjust the power level (e.g., current level, voltage level) provided to the lamp set as a function of the filament detection circuit 144, 244. Accordingly, embodiments of the present invention eliminate/reduce the risk of electric shock associated with attempting to ignite of a lamp set 106 having missing or improperly connected lamps. For example, in some embodiments, the present invention provides a ballast 104 that will pass the Risk of Shock (ROS) test outlined in Underwriters Laboratories (UL) standard 935. The ROS test involves measuring current flowing though a lamp of a lamp set 106 when only one side of the lamp (e.g., one lamp filament) is connected to the ballast 104 and the other side of the lamp (e.g., other lamp filament) is tied to a resistor connected earth ground. In order to pass the test, the measured current must be less than a specified value (UL standard 935, table 24.1). In general, the largest current that is provided by a ballast 104 to a lamp set 106 to operate the lamp set 106 occurs during ignition. By disabling ignition or lowering the current level provided by the lamp set 106 when only one side of a lamp is connected to the ballast 104, and embodiment of the present invention provides a ballast 104 that will pass the ROS test

It is intended that the lamp filament detection circuit 144, 244 may be configured for detecting a state of connection of a particular number (e.g., 1, 2, 3, 4 . . . n) of one or more lamp filaments to secondary winding L2 of the heating transformer, and may be configured for use with various lamp types, and the lamps may be connected together in a series or parallel configuration.

The methods and systems described herein are not limited to a particular hardware or software configuration, and may find applicability in many computing or processing environments. The methods and systems may be implemented in hardware or software, or a combination of hardware and software. The methods and systems may be implemented in one or more computer programs, where a computer program may be understood to include one or more processor executable instructions. The computer program(s) may execute on one or more programmable processors, and may be stored on one or more storage medium readable by the processor (including volatile and non-volatile memory and/or storage elements), one or more input devices, and/or one or more output devices. The processor thus may access one or more input devices to obtain input data, and may access one or more output devices to communicate output data. The input and/or output devices may include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processor as provided herein, where such aforementioned examples are not exhaustive, and are for illustration and not limitation.

The computer program(s) may be implemented using one or more high level procedural or object-oriented programming languages to communicate with a computer system; however, the program(s) may be implemented in assembly or machine language, if desired. The language may be compiled or interpreted.

As provided herein, the processor(s) may thus be embedded in one or more devices that may be operated independently or together in a networked environment, where the network may include, for example, a Local Area Network (LAN), wide area network (WAN), and/or may include an intranet and/or the internet and/or another network. The network(s) may be wired or wireless or a combination thereof and may use one or more communications protocols to facilitate communications between the different processors. The processors may be configured for distributed processing and may utilize, in some embodiments, a client-server model as needed. Accordingly, the methods and systems may utilize multiple processors and/or processor devices, and the processor instructions may be divided amongst such single- or multiple-processor/devices.

The device(s) or computer systems that integrate with the processor(s) may include, for example, a personal computer(s), workstation(s) (e.g., Sun, HP), personal digital assistant(s) (PDA(s)), handheld device(s) such as cellular telephone(s) or smart cellphone(s), laptop(s), handheld computer(s), or another device(s) capable of being integrated with a processor(s) that may operate as provided herein. Accordingly, the devices provided herein are not exhaustive and are provided for illustration and not limitation.

References to “a microprocessor” and “a processor”, or “microprocessor” and “the processor,” may be understood to include one or more microprocessors that may communicate in a stand-alone and/or a distributed environment(s), and may thus be configured to communicate via wired or wireless communications with other processors, where such one or more processor may be configured to operate on one or more processor-controlled devices that may be similar or different devices. Use of such “microprocessor” or “processor” terminology may thus also be understood to include a central processing unit, an arithmetic logic unit, an application-specific integrated circuit (IC), and/or a task engine, with such examples provided for illustration and not limitation.

Furthermore, references to memory, unless otherwise specified, may include one or more processor-readable and accessible memory elements and/or components that may be internal to the processor-controlled device, external to the processor-controlled device, and/or may be accessed via a wired or wireless network using a variety of communications protocols, and unless otherwise specified, may be arranged to include a combination of external and internal memory devices, where such memory may be contiguous and/or partitioned based on the application. Accordingly, references to a database may be understood to include one or more memory associations, where such references may include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, may include one or more intranets and/or the internet. References herein to microprocessor instructions or microprocessor-executable instructions, in accordance with the above, may be understood to include programmable hardware.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

What is claimed is:

1. A ballast comprising:
a driver circuit to generate an oscillating current signal;
a filament heating circuit to heat filaments of at least one lamp connected to the ballast, wherein the filament heating circuit comprises:
a heating transformer having a primary winding and a secondary winding, each adapted to conduct current, wherein the primary winding is connected to the driver circuit and the secondary winding is coupled to the primary winding and adapted to be connected to the at least one lamp; and
a switching circuit connected to the primary winding, wherein the switching circuit has a duty cycle to control the current signal provided from the driver circuit to the primary winding to heat the at least one lamp;
a current detector circuit connected to the switching circuit to detect a particular parameter of the current conducted by the primary winding, wherein the particular parameter is indicative of a total number of particular lamp filaments connected to the ballast; and
a control circuit connected to the current detector circuit and to the driver circuit, wherein the control circuit is configured to generate and transmit an output signal to the driver circuit based on the particular parameter detected by the current detector circuit.

2. The ballast of claim 1, wherein the particular parameter is peak current.

3. The ballast of claim 1, wherein the secondary winding of the filament heating transformer is adapted to connect to parallel-connected lamp filaments.

4. The ballast of claim 1, wherein the control circuit is configured to generate and transmit a control signal to the driver circuit to prevent ignition of the at least one lamp based on the particular parameter detected by the current detector circuit.

5. The ballast of claim 1, wherein the control circuit is configured to generate and transmit an output signal to the driver circuit indicative of the total number of lamp filaments connected to the secondary winding based on the particular parameter detected by the current detector circuit.

6. The ballast of claim 1, wherein the current detector circuit is configured to generate a voltage signal representing the particular parameter, and the control circuit is configured to receive the voltage signal and compare it to a reference voltage value in order to determine a total number of lamp filaments connected to the secondary winding.

7. A ballast comprising:
a filament heating transformer having a primary winding to conduct a first current and a secondary winding coupled to the primary winding to conduct a second current, wherein the secondary winding is adapted to be connected to a set of one or more lamp filaments in at least one lamp and to provide the second current to the set of one or more lamp filaments to heat the set of one or more lamp filaments, wherein the first current is a function of the second current; and
a filament detection circuit connected to the primary winding of the filament heating transformer to detect a particular parameter of the first current and to determine a total number of lamp filaments connected to the secondary winding of the filament heating transformer based on the detected particular parameter of the first current.

8. The ballast of claim 7, further comprising a driver circuit connected to the primary winding of the filament heating transformer to provide an oscillating current, wherein the first current is generated from the oscillating current.

9. The ballast of claim 7, wherein the particular parameter is peak current.

10. The ballast of claim 7, wherein the filament detection circuit comprises a current detector circuit to detect the particular parameter of the first current and to generate a voltage value representing the detected particular parameter, and wherein the filament detection circuit comprises a control circuit to receive the generated voltage value and to determine a total number of lamp filaments connected to the secondary winding of the filament heating transformer as a function thereof.

11. The ballast of claim 10, wherein the control circuit is configured to compare the received generated voltage value to a reference voltage value in order to determine a total number of lamp filaments connected to the secondary winding of the filament heating transformer.

12. The ballast of claim 10, wherein the ballast is configured to be connected to a lamp set comprising two lamps connected together in series.

13. The ballast of claim 10, wherein the ballast is configured to prevent ignition of the lamp set when the received generated voltage value is less than reference voltage value and greater than a minimum voltage value.

14. The ballast of claim 7, wherein the secondary winding of the filament heating transformer is adapted to be connected to parallel-connected lamp filaments.

15. The ballast of claim 7, wherein the ballast is configured to be connected to a lamp set comprising a plurality of lamps connected together in series.

16. The ballast of claim 7, wherein the ballast is configured to be connected to a lamp set comprising a plurality of lamps connected together in parallel.

17. A lamp system comprising:
a lamp set comprising at least one lamp, wherein the at least one lamp has a first lamp filament and a second lamp filament; and
a ballast to energize the lamp set, wherein the ballast is connected to the first lamp filament of the at least one lamp, the ballast comprising:
a driver circuit to provide an oscillating current signal;
a filament heating transformer having a primary winding and a secondary winding coupled to the primary winding, wherein the primary winding is connected to the driver circuit to conduct a first current generated from the oscillating current signal provided by the driver circuit, wherein the secondary winding is adapted to be connected to the second lamp filament to conduct a second current to the second lamp filament to heat the second lamp filament, wherein the first current is a function of the first current; and
a filament detector circuit to sense a parameter of the first current indicative of the total number of lamp filaments connected to the secondary winding of the heating transformer and preventing ignition of the lamp set based on the indicated total number of lamp filaments.

18. The lamp system of claim 17, wherein the second lamp filament is tied to a resistor connected to earth ground to perform a risk of shock test.

19. The lamp system of claim 18, wherein the lamp set further comprises a second lamp having a third lamp filament and a fourth lamp filament connected to the ballast.

20. The lamp system of claim 19, wherein the secondary winding is adapted to be connected to the second filament of the first lamp and the third filament of the second lamp connected together in parallel.
